(19) United States
(12) Patent Application Publication
(10) Pub. No.: US 2009/0109183 A1
(43) Pub. Date: Apr. 30, 2009

(54) Remote Control of a Display

(75) Inventors: Santiago Carvajal, West Newton, MA (US); John Michael Sakalowsky, West Newton, MA (US); Conor Sheehan, Brookline, MA (US)

Correspondence Address: Bose Corporation;c/o Donna Griffiths, The Mountain, MS 40, IP Legal - Patent Support, Framingham, MA, 01701, US

(73) Assignee: BOSE CORPORATION

(21) Appl. No.: 11/929,722

(22) Filed: Oct. 30, 2007

(51) Int. Cl. G06F 3/041

(52) U.S. Cl. 345/173

(57) ABSTRACT

Input data is received via a touchpad of a remote control. In a relative mapping mode, the input data is used to select a menu on a display. In an absolute mapping mode, the input data is used to select an item from multiple items on the selected menu on the display. The input data is analyzed to determine whether to enable the relative mapping mode or the absolute mapping mode. The relative mapping mode or the absolute mapping mode is automatically enabled based on analysis of the input data.

### BACKGROUND

This specification describes a remote control with a touchpad.

### SUMMARY

In one aspect, input data is received via a touchpad of a remote control. In a relative mapping mode, the input data is used to select a menu on a display. In an absolute mapping mode, the input data is used to select an item from multiple items on the selected menu on the display. The input data is analyzed to determine whether to enable the relative mapping mode or the absolute mapping mode. The relative mapping mode or the absolute mapping mode is automatically enabled based on analysis of the input data. In the absolute mapping mode, areas of the touchpad may be mapped to geographically corresponding items on the selected menu. The touchpad may be positioned above actuatable elements used to provide the input data. Predefined interactions with the touchpad may correspond to the input data. The predefined interactions may include at least one of speed, acceleration, direction or distance corresponding to the interaction. The predefined interactions may include applied pressure at a side of the touchpad. The input data may correspond to data that may be generated by electronically sweeping a pressure-sensitive surface of the touchpad to locate a position of an element on the touchpad and by monitoring actuatable elements that may be positioned beneath the touchpad.

In another aspect, a system includes an apparatus that is configured to receive input data via a touchpad of a remote control. In a relative mapping mode, the input data is used to select a menu on a display. In an absolute mapping mode, the input data is used to select an item from multiple items on the selected menu on the display. The apparatus includes memory configured to store instructions for execution and one or more processing devices configured to execute the instructions. The instructions cause the one or more processing devices to analyze the input data to determine whether to enable the relative mapping mode or the absolute mapping mode. The instructions also cause the one or more processing devices to automatically enable the relative mapping mode or the absolute mapping mode based on analysis of the input data. The system may further include the remote control. The remote control may include the touchpad and may be configured to send the input data to the apparatus. The system may further include a display device. The display device may include the display. The apparatus of the system may further include the remote control. In the absolute mapping mode, areas of the touchpad may be mapped to geographically corresponding items on the selected menu. The touchpad may be positioned above actuatable elements used to provide the input data. Predefined interactions with the touchpad may correspond to the input data. The predefined interactions may include at least one of speed, acceleration, direction or distance corresponding to the interaction. The remote control may be configured to electronically sweep a pressure-sensitive surface of the touchpad to locate a position of an element on the touchpad and to monitor actuatable elements that may be positioned beneath the touchpad to generate data corresponding to the input data.

In another aspect, a method includes automatically transitioning between a relative mapping mode and an absolute mapping mode based on analysis of input data received via a touchpad of a remote control. In a relative mapping mode, the input data is used to select a menu on a display. In an absolute mapping mode, the input data is used to select an item from multiple items on the selected menu on the display.

In another aspect, an on-screen display is launched as first video content on a display of a display device in response to first input data received via a touchpad of a remote control. The on-screen display includes multiple menus. The on-screen display, when launched, overlays at least a portion of second video content shown on the display. The display device and the remote control are separate physical devices. A menu of the multiple menus is activated to reveal items in response to second input data received via the touchpad of the remote control. A revealed item of an activated menu is selected in response to third input data received via the touchpad of the remote control. The second video content is modified in response to selection of the revealed item. Focus on a particular menu of the multiple menus may be provided by highlighting the particular menu. Focus may be shifted between menus of the multiple menus responsively to fourth input data. The activating the menu of the multiple menus may further include enlarging the menu relative to another menu of the multiple menus. The selecting of the revealed item may further include highlighting the revealed item.

The foregoing method may be implemented as a computer program product comprised of instructions that are stored on one or more machine-readable media, and that are executable on one or more processing devices. The foregoing method may be implemented as an apparatus or system that includes one or more processing devices and memory to store executable instructions to implement the method. A graphical user interface may be generated that is configured to provide a user with access to and at least some control over stored executable instructions to implement the method.

The details of one or more examples are set forth in the accompanying drawings and the description below. Further features, aspects, and advantages are apparent in the description, the drawings, and the claims.

### BRIEF DESCRIPTION OF THE SEVERAL VIEWS OF THE DRAWING

FIG. 1 is a block diagram of an entertainment system with a remote control and display device;

FIGS. 2, 3A, and 3B are diagrams of screenshots and a remote control with a touchpad;

FIG. 4A is a diagram illustrating a first mapping of the touchpad in absolute mapping mode;

FIG. 4B is a diagram illustrating a second mapping of the touchpad in absolute mapping mode;

FIG. 5 is a diagram of the touchpad showing x-y axes;

FIG. 6-9 are diagrams of screenshots and the remote control with the touchpad; and

FIG. 10 is a flow diagram of an example process that may be performed by the entertainment system.

### DETAILED DESCRIPTION

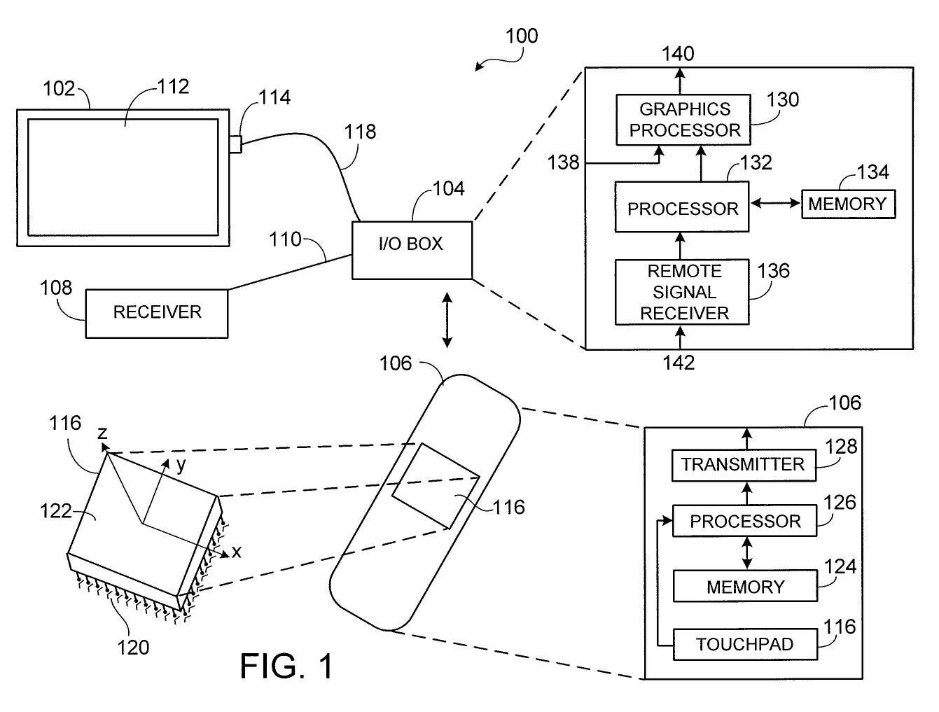

FIG. 1 shows a block diagram of an entertainment system 100. The system 100 includes a display device 102, a video junction input/output (I/O) box 104, and a remote control 106. The video junction box 104 is configured to receive an audio/video feed from a receiver 108 over a communications link 110. The receiver 108 is configured to provide a video feed of video and audio content to the I/O box 104 via the communications link 110.

The receiver 108 may be a cable, satellite, or wireless network receiver that in turn may communicate with a cable, satellite or wireless network or network provider (not shown) via a wired communications link, a wireless communications link, or a combination thereof. In other implementations, the receiver 108 may be physically located within the I/O box 104, or vice versa.

The display device 102 includes a screen 112, such as an interface screen, that is configured to display video output from the display device 102. The display device 102 may be a television device that further includes an HDMI (High Definition Multimedia Interface) interface 114 that is configured to receive high definition (HD) signals and control signals from the I/O box 104 via a link 118. A graphical user interface may be displayed on the screen 112. As described in more detail below, video output (or video content) forming a graphical user interface, such as an on-screen display (OSD) may be launched and overlaid over other video output (or video content) exhibited on the screen 112.

The remote control 106 includes a touchpad 116 that is configured to be touched and/or pressed by a user. A user may touch and/or press the touchpad 116 using a digit, finger or thumb, fingertip, a stylus, or another suitable instrument. In an implementation, the remote control 106 may include a memory 124, a processor 126, and a transmitter 128. When a user touches and/or presses the touchpad 116, information concerning these events may be transferred to the processor 126 which may store the information in the memory 124. During operation, the processor 126 may process the information from the touchpad 116 and possibly other information and transmit the processed data as control data to the I/O box 104 via transmitter 128. Thus, the control data may include input data from the touchpad 116. That is, the input data from the touchpad may be processed by the processor 126 of the remote control prior to being transmitted to the I/O box 104 (via transmitter 128) as processed input data. In other implementations, unprocessed input data from the touchpad 116 may be sent directly to the I/O box 104 via transmitter 128. The remote control 106 need not include a memory or a processor; rather, the remote control 106 may transmit data directly from the touchpad to the I/O box 104. In an implementation, infrared or radio frequency signals carrying data may be sent from the remote control 106 to the I/O box 104.

In an implementation, the I/O box 104 may include a graphics processor 130, a processor 132, a memory 134, a remote signal receiver 136, and interfaces 138, 140, 142. The I/O box 104 is configured to receive at the interface 138 a video feed from the receiver 108 via the communications link 110. The video feed from the receiver 108 may be input to the graphics processor 130 from the interface 138. The I/O box 104 is likewise configured to receive control data, including input data from the touchpad 116 of the remote control 106 in the form of signals (such as infrared signals). The I/O box 104 is configured to receive the control data at the interface 142 and the remote signal receiver 136. The processor 132 may utilize the memory 134 to store processed and unprocessed control data from the remote control 106. During operation of the system 100, the processor 132 of the I/O box 104 may process control data (including input data) from the remote control 106 to control operation of the display device 102. The processor 132 of the I/O box 104 may also process the control data from the remote control 106 to create a video feed that the I/O box 104 may combine with the video feed from the receiver 108 at the graphics processor 130 to form a combined video feed. The combined video feed from the graphics processor 130 may be sent by the I/O box 104 to the HDMI interface 114 of the display device 102 via link 118.

The touchpad 116 of the remote control 106 may be positioned above an array of actuatable elements 120. The actuatable elements 120 are illustrated in FIG. 1 as switch elements located underneath the touchpad 116. In an implementation, the actuatable elements are mechanical switches such as momentary switches. The mechanical switches may be tactile so that a user pushing, pressing or otherwise actuating the touchpad 116 will perceive a physical sensation akin to pressing a physical element such as a button. The switches, upon being pressed may give an audible physical “click” or other indication that contributes to the sensory experience provided to the user in pressing the touchpad 116 on the remote control 106. The switches may thus provide kinesthetic and auditory confirmation of a user's action on the touchpad 116. In an implementation, pressed or pushed touchpad 116, causes the actuatable elements 120 to contact and close a circuit which in turn creates data indicative of the touchpad being pressed or pushed. The touchpad 116 will generally be pushed in the z-direction (inward toward the remote) to “click” the actuatable elements 120.

The touchpad 116 itself may include a pressure sensitive surface 122 that the remote control 106 may use to perceive a touch on the touchpad 116. In an implementation, the pressure sensitive surface of the touchpad 116 may be electronically swept to monitor and determine the position of (for example) a user's finger on the touchpad 116. The pressure sensitive surface 122 of the touchpad 116 may have a corresponding x-y based coordinate system mapping that provides unique and precise identification of the location of the user's finger on the surface of the touchpad 116. The location of the user's finger at any particular monitored moment may be given by an x and y coordinate pair (x, y). Through storage of the coordinate data on, for example, the memory 134 of the I/O box 104 and/or the memory 124 of the remote control 106, the location of a user's finger on the touchpad 116 may be tracked so that a variety of measurements may be determined from the coordinate data. For example, measurements such as the distance and the direction traveled by the user's finger over the touchpad 116 as well as the speed and acceleration of the user's finger on the pad may be determined.

In an implementation, the touchpad 116 may implement electrical (e.g., resistive) switching to monitor and determine the position of (for example) a user's finger on the touchpad 116. In other implementations, other forms of switching may be used, such as capacitive switching. In this implementation, when a user touches the pressure sensitive surface 122 of the touchpad 116, the surface 122 makes contact with another layer of the touchpad 116 to complete a circuit that provides an indication that the user has touched the surface 122. The location of the user's finger may be given via an x and y coordinate pair. The touchpad 116 may be electronically swept at time intervals to continually monitor the location of a user's finger on the touchpad 116. In other implementations, the touchpad 116 may implement pressure sensitivity so that if the amount of pressure applied to a surface of the touchpad 116 exceeds a certain threshold (such as when a user's finger touches the touchpad 116), the touchpad 116 will provide an indication that the user has touched the surface 122.

In implementations in which the actuatable elements 120 such as mechanical momentary switches are positioned beneath the touchpad 116, the amount of pressure that may be required for the pressure sensitive surface 122 to sense a touch on the touchpad 116 will in general be much less that the amount of pressure required to actuate the actuatable elements 120 so that a “click” of the touchpad is registered by the remote control 106. That is, a subtle touch of a user's finger upon the surface 122 of the touchpad 116 may be sufficient to register the position of the user's finger on the touchpad 116.

In an implementation, the processor 132 of the I/O box 104 receives input data from the touchpad indicative of a user actuating the touchpad 116 (e.g., a click of the touchpad). The input data may include both an indication that the user actuated the actuatable elements 120 of the touchpad 116 (an indication generated by the actuatable elements 120 themselves) and an indication of the position (in terms of an x and y coordinate pair) at which the actuation occurred on the touchpad 116 (an indication generated by the pressure sensitive surface 116 itself).

In other implementations, the I/O box 104 may be physically located within the display device 102 or the remote control 106, or the functions of the I/O box 104 may be otherwise integrated into the display device 102 or the remote control 106. In other implementations, the receiver 108 may be physically located within the display device 102, or the functions of the receiver 108 may be otherwise integrated into the display device 102. In other implementations, both the receiver 108 and the I/O box 104, or the functions thereof, may be combined or otherwise integrated into the display device 102. Many other implementations and system arrangements using the I/O box 104, the display device 102, the receiver 108, and the remote control 106, and/or the functions thereof, are possible.

The processor 126 of the remote control 106 and the processor 132 of the I/O box 104 may each include one or more microprocessors. The memory 124 of the remote control 106 and the memory 134 of the I/O box 104 may each include a random access memory storage device, such as a dynamic random access memory, one or more hard drives, a flash memory, and/or a read only memory, or other types of machine-readable medium memory devices.

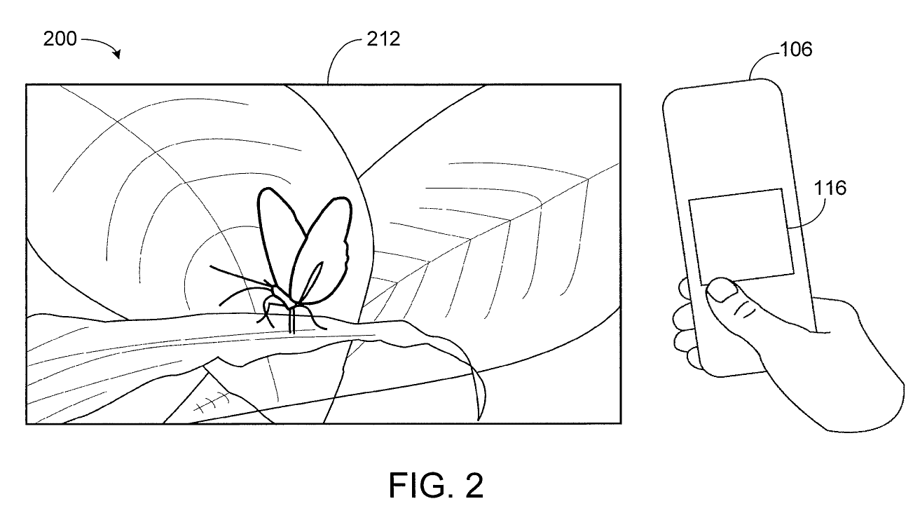

FIG. 2 shows a screenshot 200 of a screen 212 such as screen 112 along with the remote control 106. A hand of a user is shown holding the remote control 106 with a thumb of the user place directly below the touchpad 116 of the remote control 106. The screen 212 shows HD (or other) video output that may be sourced by a service provider such as a cable or satellite television content service provider.

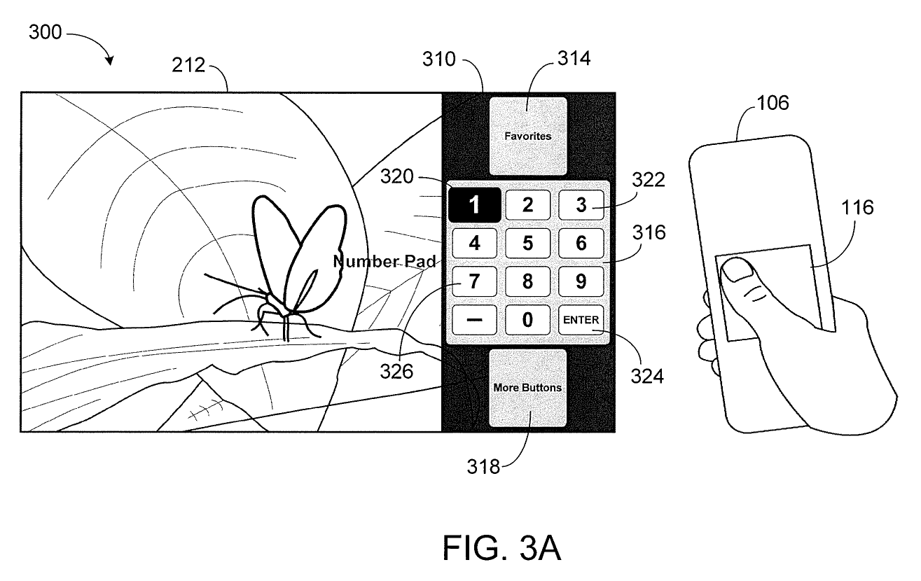

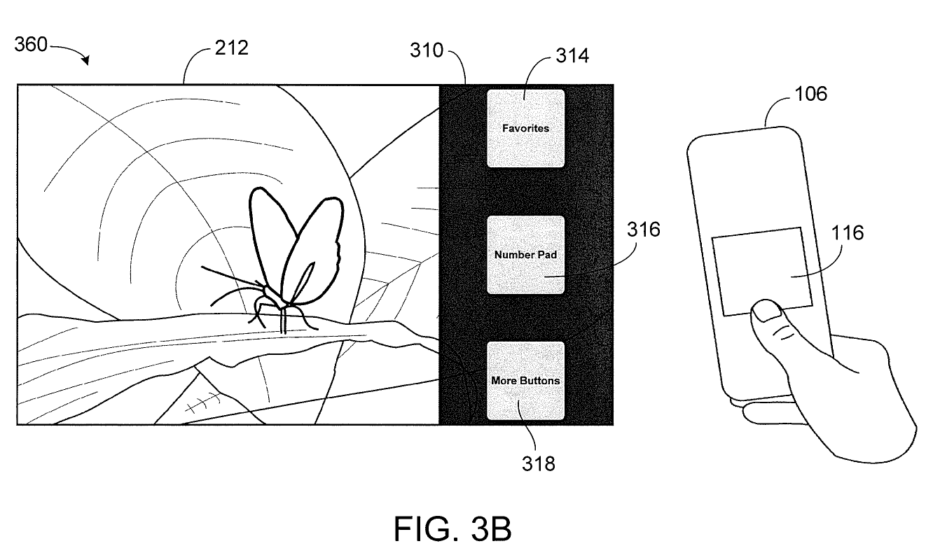

In FIG. 3A, a screenshot 300 shows the HD video output with an overlaid graphical user interface such as an on-screen display (OSD) 310. The OSD 310 may be generated by the I/O box 104 and may be overlaid with the HD video (or other) output at the graphics processor 130 of the I/O box 104. The OSD 310 may include three menus, such as the “Favorites” menu 314, the “Number Pad” menu 316, and the “More buttons” menu 318. In the screenshot 200 of FIG. 2, the OSD 310 is dormant or not active and thus is not shown on the screen 212. In an implementation, the OSD 310 is activated as on FIG. 3A by a light touch or a press of the user's finger on the touchpad 116. Upon activation, the OSD 310 appears on the screen 212 as in FIG. 3A. In an implementation, upon activation and launch the OSD 310 defaults to the Number Pad menu 316, as shown in FIG. 3A. The Number Pad menu may be highlighted, provide more information and shown as larger than the other, non-selected menus 314, 318 which currently only display their titles. A list of number items from 0 to 9 are shown as buttons items on the Number Pad menu 316. In an implementation, an “Enter” button item 324 may be used to enter a numeric sequence selected by the user using the number items from 0 to 9 (e.g., a channel 39 by pressing “0” “3” “9” “ENTER”). In an implementation, video output (or video content) appearing on the screen 212 under the overlaid OSD 310 may be changed or modified responsively to a user's selection (via the touchpad 116) of items on the OSD 310.

Certain actions performed by the user on the touchpad 116 of the remote control 106, such as a touch, a press, or a movement of the user's finger along the touchpad 116 may cause input data to be generated from the touchpad 116 of the remote control 106. The input data corresponding to the action performed by the user on the touchpad 116 may be analyzed and interpreted by a processor (such as processor 132 on the I/O box 104) to make changes to the video feed that becomes the OSD 310 on the screen 212. For example, the user pressing and/or touching the touchpad when the OSD 310 is dormant (i.e., not shown on the screen 212) may cause the OSD 310 to become active and launch on the screen 212 as in FIG. 3A.

In another implementation, upon activation and launch the OSD 310 may display the three menus 314, 316, 318 as shown in a screenshot 360 of FIG. 3B without defaulting to a particular menu such as menu 316. In an implementation, the OSD 310 is activated as on FIG. 3B by a light touch or a press of the user's finger on the touchpad 116.

The remote control 106 and the touchpad 116, in combination with the OSD 310 may be configured to operate in either of two modes, a relative mapping mode and an absolute mapping mode, according to interactions of the user with the touchpad 116.

In the relative mapping mode, the touchpad 116 surface is mapped relatively to a graphical user interface such as the OSD 310. In an implementation, relative mapping may map the touchpad 116 surface to a larger screen area of the screen 212 than just the OSD 310. In the relative mapping mode, a user's interactions with the touchpad 116, such as moving a finger across the touchpad 116, may map relatively to the screen 212 so that, for example, a pointer or cursor moves in that direction across the screen 212. For example, moving a finger along the touchpad 116 from one extreme of the touchpad 116 (say the lower left) to another extreme (say the upper right) may cause the pointer or cursor merely to move a short distance on the screen 212 in the same direction, rather than from one extreme of the screen 212 to another. As another example, placing a finger on the lower left portion of the touchpad 116 may correspond, for example, to an area more to the upper right of the screen 212, rather than to the lower left portion of the screen 212.

In another implementation, in relative mapping mode, focus (rather than a cursor or a pointer) may be shifted between various menus on the OSD 310. An upwards or downwards gesture by the user's finger across the keypad may shift focus upwards or downwards from a selected menu, respectively to other menu(s) (if present and available) located above or below the selected menu, respectively. The screenshot 360 of FIG. 3B is an example of the relative mapping mode in which an upwards or downwards gesture by the user's finger may shift focus between the menus 314, 316, 318.

In the absolute mapping mode, a user's interactions with the touchpad 116 may map geographically to a menu on the screen 212. In an implementation, the items of a menu map in terms of geographic scale to the touchpad 116 so that a user's interaction with the touchpad 116 in the lower left of the touchpad 116 will map to a corresponding area in the lower left of the menu on the screen 212. The dimensions of the touchpad 116 map in an absolute sense to the dimensions of the menu (or other portion of the screen to which the touchpad is mapped). For example, the x and y coordinates of the pad may be proportional in scale to those of the menu to which the touchpad is mapped.

Interactions of the user with the touchpad 116 of the remote control 106 may be predefined and programmed to cause the I/O box 104 to automatically transition from the absolute mapping mode to the relative mapping mode in the OSD 310 in the screen 212, or vice versa. The input data corresponding to the action performed by the user on the touchpad 116 may be analyzed and interpreted by a processor (such as processor 132 on the I/O box 104) to make changes to the video feed that becomes the OSD 310 on the screen 112. As described in more detail below, the input data from the touchpad 116 may be analyzed by the processor 132 to determine whether to enable the relative mapping mode or the absolute mapping mode. The relative mapping mode or the absolute mapping mode may be automatically enabled based on the processor 132's analysis of the input data. In other implementations, some or all of the processing that may be used to determine whether to enable the relative mapping mode or the absolute mapping mode, such as analysis and interpretation of the input data received from the touchpad 116, may be performed by the processor 126 of the remote control 106.

In an implementation, FIG. 3B may represent the OSD 310 in relative mapping mode, where interactions by the user with the touchpad 116 (such as user's moving her finger along or across the touchpad 116 or touching or pressing an extreme of the touchpad 116 with her finger) may cause the OSD 310 to switch focus between menus 314, 316, 318. A particular menu of the menus 314, 316, 318 may be highlighted to show that focus is on the particular menu. In an implementation, a user's interactions with the touchpad 116 (such as clicking the touchpad 116 or removing her finger from the touchpad 116 when focus is on a particular menu) may cause the OSD 310 to select the particular menu, enlarge the menu relative to the other menus, reveal the items for that menu, and enable the absolute mapping mode for that menu, as shown in FIG. 3A with Number Pad menu 316, for example.

An example of absolute mapping mode is shown in FIG. 3A, where the OSD 310 is launched and provides focus on the Number Pad menu 316 so that the touchpad 116 is mapped geographically to the Number Pad menu 316. In FIG. 3A, the user's thumb touches the upper left corner of the touchpad 116 on the remote control 106 which maps to the “1” button item 320 on the Number Pad menu 316. The button item 320 may be highlighted on the OSD 310 to indicate to the user that her thumb is placed in the appropriate physical position to select the highlighted button item. Any other button item on the Number Pad menu 316 may be highlighted responsively to corresponding contact by the user's thumb at the respective position of the button item on the touchpad 116. For example, if the user lifts her thumb from the upper left of the touchpad 116 and places it on the upper right of the touchpad 116, the “3” button item 322 would be highlighted (not shown) on the OSD 310. In an implementation, to select the highlighted button item, such as the “1” button item 320, the user may press or click the touchpad 116. The touchpad 116 may move physically in the z-dimension (i.e. inward toward the remote) so that the touchpad 116 together with the actuatable elements such as elements 120 provide the user with tactile feedback in response to the applied pressure on the touchpad 116. In an implementation, auditory feedback such as a “click” is provided in response to a click of the touchpad 116.

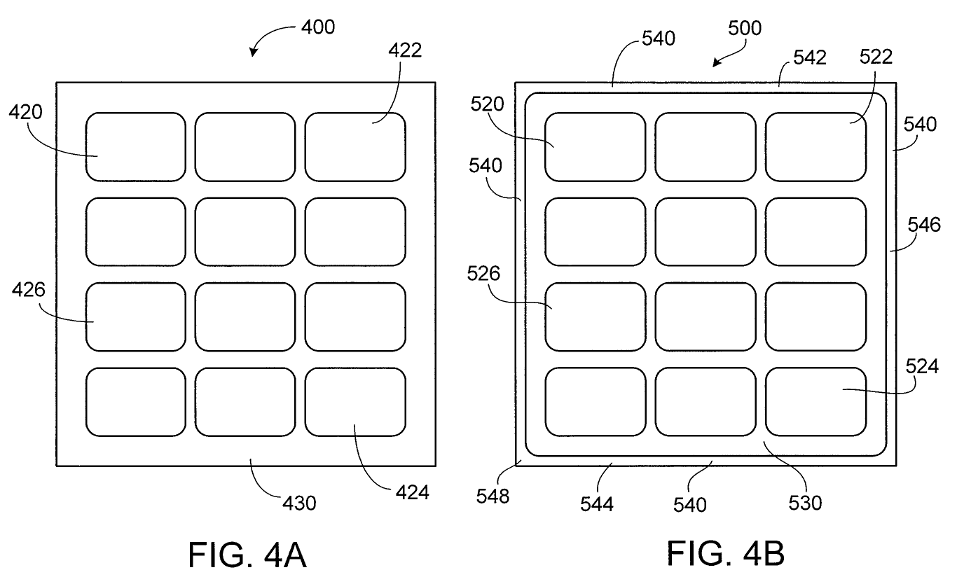

FIGS. 4A and 4B are diagrams showing example geographic mappings of the pressure sensitive surface 122 of the touchpad 116 to the Number Pad menu 316 of the OSD 310 of FIG. 3A in absolute mapping mode. In an implementation, enabling the absolute mapping mode causes the pressure sensitive surface 122 to be rescaled so that positions on the surface 122 are mapped geographically to corresponding positions on a menu.

FIG. 4A shows an example mapping 400 of the touchpad 116 in absolute mapping mode. Positioning a user's finger so that it contacts the touch pad in the area 420 of the surface 122 of the touchpad 116 corresponds to the “1” button item 320 of the Number Pad menu 316 of FIG. 3A. Contact in the areas 422, 424, 426, respectively, geographically corresponds to the “3,” “Enter,” and “7” button items 322, 324, 326 of the Number Pad menu 316. In contrast, touching the surface 122 of the touchpad 116 at any portion 430 of the touchpad 116 that is not mapped to the Number Pad menu 316 will, in general, have no effect on selection of the button items on the menu 316.

In an implementation, the areas such as areas 420, 422, 424, 426 that map to button items on the Number Pad menu 316 may be smaller and, spaced further apart then would result from an exact absolute mapping of the touchpad 116 to the Number Pad menu 316 to provide less chance that the touch or press of a user will overlap two adjoining areas at the same time. The areas may be 15 to 20 percent smaller than an exact absolute mapping of the touchpad 116 would dictate, although other percentages are suitable.

FIG. 4B is another example mapping 500 of the touchpad 116 in absolute mapping mode. The mapping 500 includes areas such as areas 520, 522, 524, 526 of the touchpad 116 that map geographically to the Number Pad menu 316 in identical fashion to that shown in the mapping 400 of FIG. 4A. The portion 530 of the touchpad 116 is likewise not mapped to the Number Pad menu 316 so that touching the surface 122 of the touchpad 116 at this portion 530 will, in general, not effect selection of the menu 316 button items. The portion 530 is somewhat smaller than the portion 430 of FIG. 4A, because the mapping 500 of FIG. 4B includes an area 540 along the perimeter of the touchpad 116.

In an implementation, when the area 540 of the touchpad 116 is touched by a user, the relative mapping mode may be enabled and focus may shift away from the menu 316 toward another menu (if available) in the direction toward which the area 540 was pressed. For example, if the part 542 of the area 540 that runs along the top of the touchpad 116 is touched by the user, the relative mapping mode would be enabled and focus would shift from the Number Pad menu 316 to the “Favorites” menu 314 of FIG. 3A. Similarly, if a user touches the part 544 of the area 540 that runs along the bottom of the touchpad 116, the relative mapping mode would be enabled and focus would shift from the Number Pad menu 316 to the “More buttons” menu 318 of FIG. 3A. In other implementations, the user may touch and click (or actuate the actuatable elements 120 beneath the touchpad 116) the area 540 in order to enable the relative mapping mode and switch focus to an adjoining menu on the OSD 310. In other implementations with more menus, the touchpad 116 can be mapped like in FIG. 4B to permit more parts of the area 540 to be touched to switch focus to more menus, accommodating sideways or diagonal directions (by clicking and touching portions such as the right side portion 546 or the lower left portion 548 of the area 540) and the like.

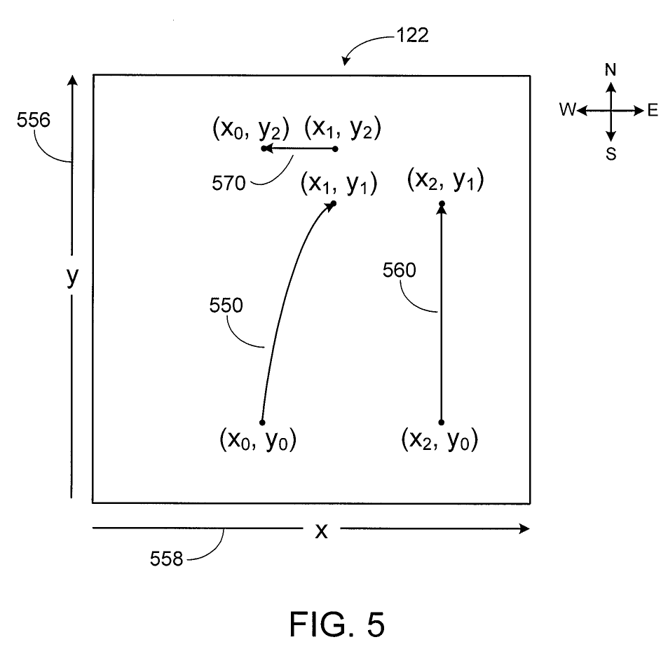

Another way in which the relative mapping mode may be enabled from the absolute mapping mode is by way of a gesture by the user, or movement of the user's finger along or across the pressure sensitive surface 122 of the touchpad 116. FIG. 5 is a diagram illustrating the pressure sensitive surface 122 of the touchpad 116 with a y axis 556 drawn along the left-hand side of the surface 122 and an x axis 558 drawn along the bottom side. An example movement of a user's finger, along a curved path 550, is tracked from a first coordinate position (x₀, y₀) to a second coordinate position (x₁, y₁) on the touchpad 116. A second example movement is along an upward path 560 and is tracked from a first coordinate position (x₂, yₒ) to a second coordinate position (x₂, y₁). A third example movement is along a leftward path 570.

In an implementation, the relative mapping mode is enabled by tracking the movement of a user's finger from a first location to a second location and analyzing the overall direction of the movement (i.e., upwards, downwards, leftwards, or rightwards) and the length of the movement. The first example movement along path 550 in FIG. 5 is overall an upwards movement since (from inspection of the diagram) x₁−xₒ (the distance traveled in the right direction) is less than y₁−yₒ (the distance traveled in the upwards direction. The second and third example movements along paths 560 and 570 are straight lines and are upward and leftward directions, respectively. The length of the movement may be tracked so to make sure that a movement to relative mapping mode is being effectuated by the user, and that a transition to relative mapping mode is not triggered by an accident or a non-event. The distance traveled either in total or in the overall direction may be compared to a threshold value so that the relative mapping mode may be enabled only if the distance traveled exceeds the threshold value, such as a majority of the length or width of the touchpad 116 surface 122. Other overall directions may be accommodated such as overall distance traveled in a diagonal (e.g., Northeast) direction. Other variables may be determined and used in combination with, or instead of distance traveled or overall direction such as the speed of movement, the acceleration of movement, the time of movement, and force or pressure accompanying the movement. Speed and/or acceleration of the movement may be monitored along with directional movement to track what may be a tendency of user to move her finger or thumb more quickly on the touchpad 116 the more distance that needs to be covered on the touchpad 116.

Tracking the gestures made by a user (e.g., the curved path 550 of FIG. 5) rather than only upward, leftward, downward, or rightward movement (e.g. paths such as upward path 560 and leftward path 570 of FIG. 5) may conform more closely to a natural, intuitive gesture of a user to move their thumb or finger along the touchpad 116 surface 122. A user of a remote control may find it more natural to move her thumb or finger in an arc rather than straight up or down, or straight left to right.

In an implementation, the relative mapping mode is enabled by either a user touching the touchpad 116 surface 122 at an extreme of the touchpad 116, such as area 540 of FIG. 4B, or by tracking a gesture by the user, or other movement of the user's finger along or across the pressure sensitive surface 122 of the touchpad 116. In other implementations, only touching the touchpad 116 surface 122 at an extreme of the touchpad 116 enables the relative mapping mode. Other implementations may require both the clicking and touching) of the touchpad 116 surface 122 at an extreme of the touchpad 116. In other implementations, only tracking of gestures or other movement by the user across the surface 122 of the touchpad 116 may enable the relative mapping mode. Generally, any combination of these techniques may be used to transition to the relative mapping mode.

As described above, a user may touch and/or press the touchpad 116 using a digit, finger or thumb, fingertip, a stylus, or another suitable instrument. In an implementation, touching or contacting the pressure sensitive surface 122 of the touchpad 116 with any of these digits or instruments may result in more than one coordinate position (x, y) being associated with the digit or instrument. A user's finger, for example, that touches or contacts the surface 122 will in general have a larger contact area with the surface 122 of the touchpad 116 than one coordinate position (x, y). In an implementation, the coordinate pairs associated with the entire contact area of the surface 122 of the touchpad 116 (that is, the part of the user's digit or instrument that contacts the surface 122) may be tracked so that the full contact area may be known at any given time. In another implementation, a portion of the contact area may be tracked as input data received via the touchpad 116.

Referring to the example touchpad 116 mappings illustrated in FIGS. 4A and 4B, a contact area defined by touch or contact of a user's digit or an instrument with the surface 122 of the touchpad 116 may overlap more than one area on the example mappings 400, 500 of the touchpad 116. For example, a user's finger might touch or contact the surface 122 so that the resulting contact area overlaps two or more areas that map geographically to items on one of the OSD 310 menus (such as the Number Pad menu 316) in the absolute mapping mode. In an implementation, when a resulting contact area of a user's digit or an instrument with the touchpad 116 simultaneously overlaps more than one area (such as areas 420, 422, 424, 426 of FIG. 4A or areas 520, 522, 524, 526, 540 of FIG. 4B), no item may be selected or highlighted on an associated menu such as the Number Pad menu 316 of FIG. 3A. In another implementation, if the resulting contact area of a digit or an instrument with the touchpad 116 simultaneously overlaps more than one of the areas in FIG. 4A or in FIG. 4B, then an item corresponding to the area that overlaps with a majority of the resulting contact area will be selected.

Likewise, a user's finger might touch or contact the surface 122 of the touchpad 116 so that the resulting contact area overlaps both an area that maps geographically to an item on one of the OSD 310 menus (such as the Number Pad menu 316) and a portion of the touchpad that is not mapped to the particular OSD 310 menu. In an implementation, when a resulting contact area of a user's digit or an instrument with the touchpad 116 simultaneously overlaps both a geographically mapped area (such as one of areas 420, 422, 424, 426 of FIG. 4A or areas 520, 522, 524, 526, 540 of FIG. 4B) and a non-mapped portion (such as portion 430 of FIG. 4A or portion 530 of FIG. 4B) of the touchpad 116, the item corresponding to the geographically mapped area that is overlapped will be selected. In another implementation, an item corresponding to a geographically mapped area (such as in FIG. 4A or 4B) may only be selected if a majority of the resulting contact area overlaps the geographically mapped area relative to one of the non-mapped portions (such as in FIG. 4A or 4B). Of course, numerous techniques of tracking contact areas of a user's digit or instrument with the surface 122 of the touchpad 116, or of interpreting data associated with the contact area, may be used.

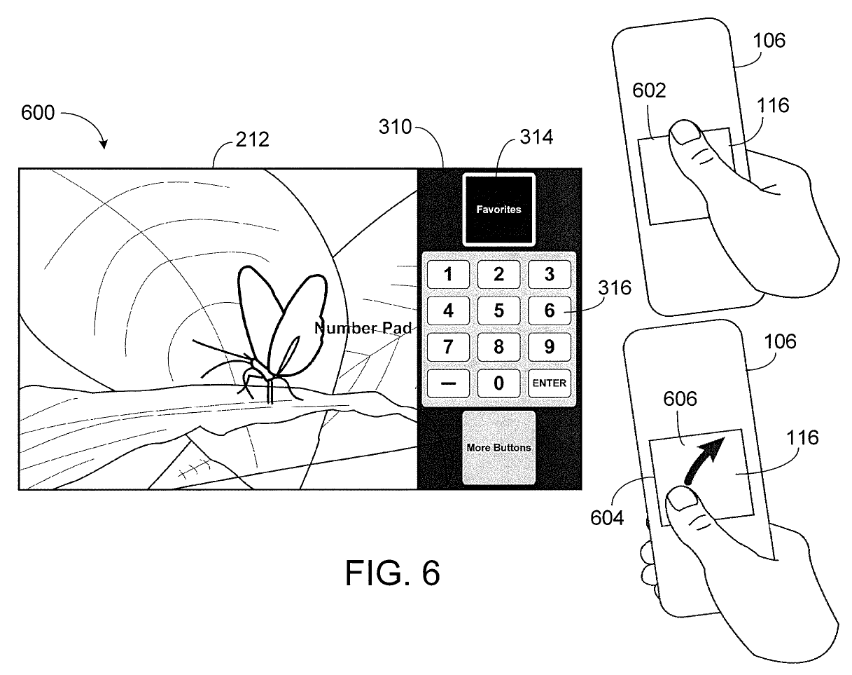

In FIG. 6, the screenshot 600 shows the Number Pad menu 316 of the OSD 310 enlarged so that the absolute mapping mode was enabled for that menu 316. Two diagrams showing the remote control 106 with the touchpad 116 are shown and illustrate two ways in which the relative mapping mode may be enabled. The first diagram corresponds to the remote control 106 applying the mapping 500 of the menu 316 (see FIG. 4B). A thumb 602 of a user is shown touching the touchpad 116 at the very top or extreme of the touchpad 116 surface 122, such as area 540 of FIG. 4B. This enables the relative mapping mode and focus will shift upward to the “Favorites” menu 314 so that the menu 314 is highlighted as shown in FIG. 6. The second diagram corresponds to an instance in which the remote control 106 recognizes a gesture 606 or movement 606 made by the user's thumb 604 across the touchpad 116. In this implementation, the movement is an overall upward movement and the relative mapping mode will be enabled with focus shifting upward to the Favorites menu 314 so that the menu 314 is highlighted in FIG. 6. In an implementation, the highlighted Favorites menu 314 (or other menu) may be selected by the user's finger clicking or actuating the touchpad 116.

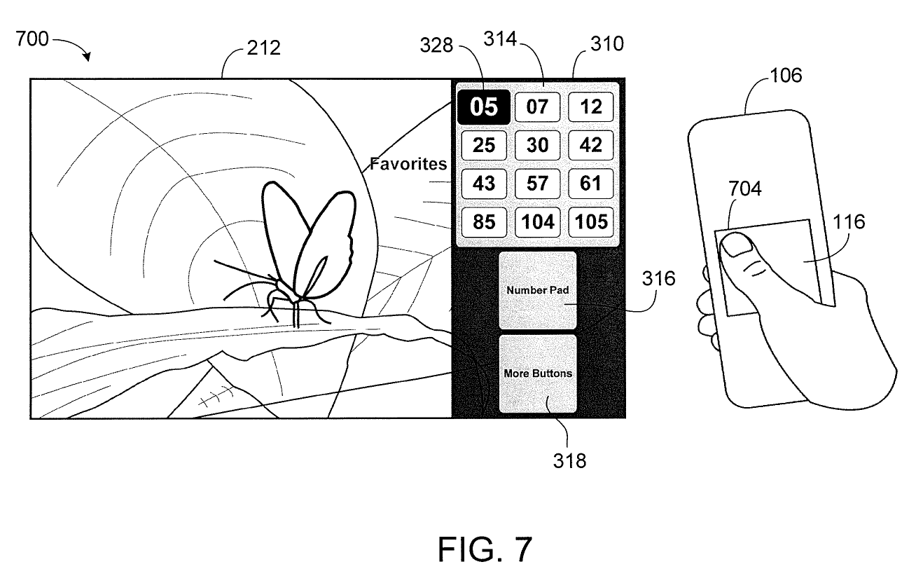

This shift in focus to the Favorites menu 314 is illustrated in FIG. 7, which shows a screenshot 700 of the OSD 310 with the Favorites menu 314 that was highlighted in FIG. 6 now selected, highlighted, and shown as larger than the non-selected menus 316, 318. An array of button items corresponding to numbers of a user's favorite channels are shown in the Favorites menu 314. With the Favorites menu 314 now selected, highlighted and active, a transition to the absolute mapping mode has been effected by the user (by the user, e.g., clicking the touchpad 116) so that the touchpad 116 is mapped geographically to the Favorites menu 314. The user's thumb 704 touches the upper left corner of the touchpad 116 on the remote control 106 which maps to the “05” button item 328 on the Favorites menu 314. The button item 328 may be highlighted on the OSD 310 to indicate to the user that her thumb 704 is placed in the appropriate physical position to select the highlighted button item. Any other button item on the Number Pad menu 316 may be highlighted responsively to corresponding contact by the user's thumb 704 at the respective position of the button item on the touchpad 116. In an implementation, to select the highlighted button item, such as the “05” button item 328, the user may click the touchpad 116 so that the touchpad 116 together with the actuatable elements 120 provide the user with tactile feedback in response to the applied pressure on the touchpad 116. In an implementation, auditory feedback such as a “click” is provided in response to a click of the touchpad 116.

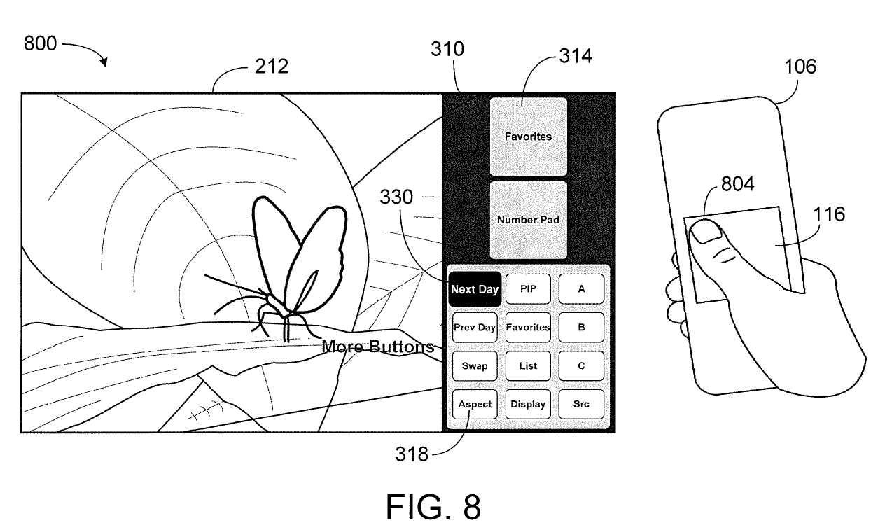

FIG. 8 shows a similar screenshot 800 along with the remote control 106, only with the “More buttons” menu 318 of the OSD 314 highlighted and active in the absolute mapping mode rather than the Favorites menu 314. The user's thumb 804 contacts the upper left corner of the touchpad 116 and the user may select the highlighted “Next Day” button item 330 by clicking the touchpad 116 in the upper left corner location shown in FIG. 8.

In other implementations, enabling the relative mapping mode from the absolute mapping mode may shift focus away from the selected menu (such as Number Pad menu 316 in FIG. 6) and return the OSD 310 to a state as shown in FIG. 3B, in which the screenshot 360 shows the menus 314, 316, 318 as not highlighted and a user may switch focus between the menus 314, 316, 318 in the relative mapping mode.

In an implementation, when the OSD 310 is activated and launched, the time period from the last activity of the user's finger on the touchpad 116 may be tracked in the absolute mapping mode and the relative mapping mode. In an implementation, after a period of inactivity, the OSD 310 may disappear from the display (see FIG. 2) or the OSD 310 may return to a state as shown in FIG. 3B, in which the screenshot 360 shows the menus 314, 316, 318 as not highlighted.

In an implementation, an immediate automatic transition may be effected between the absolute mapping mode in one menu of the OSD 310 to the absolute mapping mode in another menu of the OSD 310 responsively to a single (or minimal) interaction of the user with the touchpad 116. In an implementation, upon activation and launch the OSD 310 defaults to the Number Pad menu 316, as shown in FIG. 3A. In an implementation, if a gesture is made by the user's finger or thumb, such as the user moving her thumb along or across the touchpad 116 in an upwards motion, an immediate automatic transition to the relative mapping mode may occur, causing the full Favorites menu 314 to be highlighted, selected and active as shown in FIG. 7, followed by an immediate automatic transition to the absolute mapping mode in the menu 314. This implementation may provide a user with the ability to change from absolute mapping mode in one menu (such as menu 316) to absolute mapping mode in another menu (such as menu 314) by way of a momentary transition to the relative mapping mode with minimal user interaction with the touchpad 116. In an implementation, any intermediate transition to the relative mapping mode may not be visible or evident to the user. In an implementation, a touch or a click of the touchpad 116 at an extreme of the touchpad (rather than a gesture by the user along the touchpad 116) may cause the immediate automatic transition between the absolute mapping mode in one menu to the absolute mapping mode in another menu.

In FIGS. 3A and 6-8, menus including items in the form of buttons are shown, but other menus may be used having items such as list items, drop down lists, check box items, clickable icons, and the like. Although the button item menus in FIGS. 3A and 6-8 are illustrated in the form of a 4×3 grid of button items, a multiplicity of grid layouts may be used, including n×m grid layouts, with n the number of rows and m the number of columns. Grid layouts of 4×2 and 4×1 are easily accommodated by the touchpad 116.

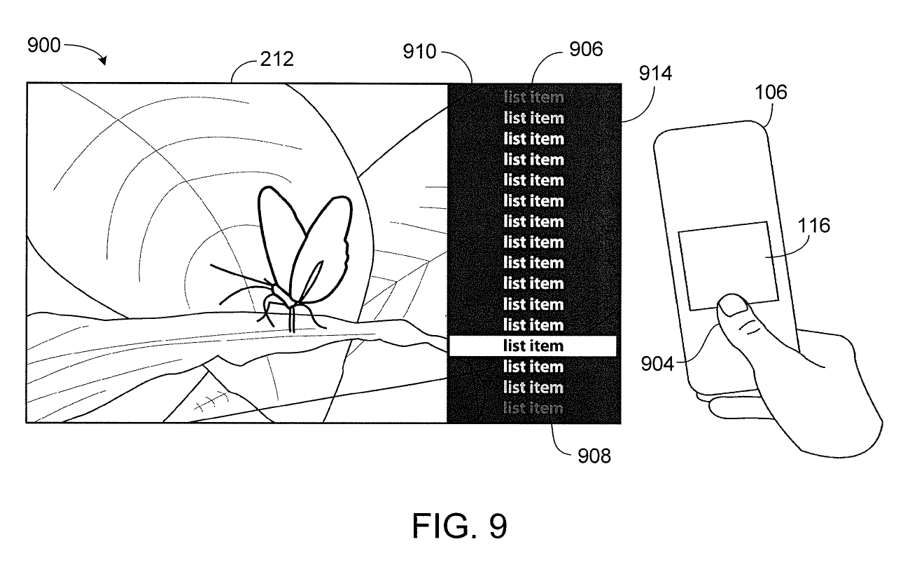

FIG. 9 shows a screenshot 900 on the screen 212 with an OSD (on-screen display) 910. The OSD 910 includes a menu 914 of “list items” with only a portion of the entire group of list items visible on the screen 212. This is illustrated by the partially visible list items 906, 908 at the top and the bottom of the menu 914. Other list items not shown on the screen 212 or visible in the OSD 910 may be part of the group of list items in the menu 914. In an implementation, the touchpad 116 is mapped geographically to the list items that are shown on the screen 212 in the OSD 910. Clicking on the touchpad 116 in the middle of the touchpad may select a corresponding list item in the middle of the list items visible in the OSD 910. To enable relative mapping, that is, to scroll upwards or downwards to additional list items not visible in the OSD 910, a user may touch the touchpad 116 at the extreme of the touchpad 116. Scrolling downward to additional list items is shown in FIG. 9 where a user's thumb 904 contacts the lower extreme of the touchpad 116. In other implementations, the touching and clicking of the touchpad 116 at its extremes may trigger upward or downward scrolling. In other implementations, tracking of gestures or other movement by the user across the surface 122 of the touchpad 116 may enable the relative mapping mode and scrolling to additional items.

An on-screen display (OSD) such as the OSD 310 of, e.g., FIG. 3A may be overlaid over other video output on the screen 112 of the display device 102 of FIG. 1. As shown in FIG. 1, the display device 102 and the screen 112 are generally located separate from the remote control 106 and the touchpad 116. Positioning the OSD on the screen of the display device apart from the remote control or from the touchpad itself may provide several advantages. For example, when a user operates the touchpad 116, such as by clicking the surface 122 of the touchpad 116 to select a button item or other item on the OSD, the action by the user's finger does not obstruct the user's view of the button being pressed, as would be the case if the OSD was located on the touchpad. In general, when manipulating a remote OSD using the touchpad 116 on the remote control 106, the focus of the user may be on the activity on the OSD, rather than on the remote or the touchpad. This provides visual accommodation for all users, but particularly for older users as it may prove difficult for users to focus on near objects (such as buttons on a remote) as they get older. A user may not need to refocus her eyes as she operates the touchpad. She may watch the OSD on a display separate from the remote control 106 and operate the touchpad 116 without looking at the remote control 106.

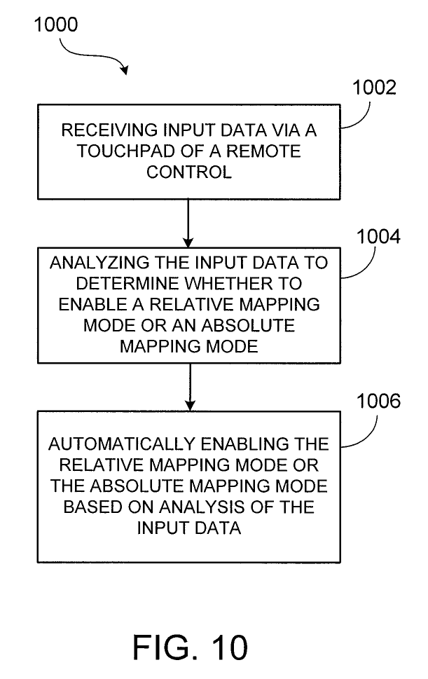

FIG. 10 shows a flow diagram of an example process that may be performed by the entertainment system 100 of FIG. 1. Input data is received via a touchpad of a remote control (1002). In an implementation, the I/O box 104 may receive input data via the touchpad 116 of the remote control 106. In other implementations, the display device 102 or the remote control 106 may receive the input data via the touchpad 116.

In an implementation, the input data may be indicative of a touch of a user's finger on the touchpad 116, a movement (such as a gesture) of a user's finger along or across the touchpad 116, a click or actuation of the touchpad 116 by a user's finger (to actuate, for example actuatable elements 120 such as mechanical momentary switches), or any combination of these or other actions performed by a user on the touchpad 116. In an implementation, the input data may correspond to data generated by electronically sweeping the pressure-sensitive surface 122 of the touchpad 116 to locate the position of a user's finger on the touchpad and to data generated by monitoring actuatable elements 120 such as mechanical switches positioned beneath the touchpad 116.

Processing continues at action 1004 where the input data is analyzed to determine whether to enable a relative mapping mode or an absolute mapping mode. In an implementation, the processor 132 of the I/O box 104 may analyze the input data (received at remote signal receiver 136 from the remote control 106) to determine whether to enable the relative mapping mode or the absolute mapping mode. In other implementations, a processor on the remote control 106 (such as the processor 126) may perform the action 1004 of analyzing the input data received via the touchpad 116. The display device 102 may also perform analysis of the input data (1004).

Processing continues at action 1006 where the relative mapping mode or the absolute mapping mode is automatically enabled based on analysis of the input data. In an implementation, the processor 132 of the I/O box 104 may automatically enable either the relative mapping mode or the absolute mapping mode based on analysis of the input data received via the touchpad 116. In other implementations, a processor on the remote control 106 or the display device 102 may perform the action 1006 of automatically enabling either the relative or absolute mapping modes.

In an implementation, in the relative mapping mode, the input data received via the touchpad of the remote control may be used to select a menu on a display. In an implementation, in the relative mapping mode, input data received via the touchpad 116 of the remote control 106 may be used by the I/O box 104 of FIG. 1 to select a menu such as the Favorites menu 314 on the OSD 310 of FIG. 2, as shown in and described above with reference to FIG. 6.

In an implementation, in the absolute mapping mode, the input data received via the touchpad of the remote control may be used to select an item from multiple items on a display. In an implementation, in the relative mapping mode, input data received via the touchpad 116 of the remote control 106 may be used by the I/O box 104 of FIG. 1 to select an item, such as the “1” button item 320 of the Number Pad menu 316 on the OSD 310 of FIG. 3A, as shown in and described above with reference to FIG. 3A.

In an implementation, in the absolute mapping mode, areas of the touchpad may be mapped to geographically corresponding items on the selected menu, as shown in and described above with reference to, e.g., FIGS. 3A, 4A, 4B, 7 and 8.

Though the elements of several views of the drawing may be shown and described as discrete elements in a block diagram and may be referred to as “circuitry”, unless otherwise indicated, the elements may be implemented as one of, or a combination of, analog circuitry, digital circuitry, or one or more microprocessors executing software instructions. The software instructions may include digital signal processing (DSP) instructions. Unless otherwise indicated, signal lines may be implemented as discrete analog or digital signal lines, as a single discrete digital signal line with appropriate signal processing to process separate streams of audio signals, or as elements of a wireless communication system.

The processes described herein are not limited to use with any particular hardware, software, or programming language; they may find applicability in any computing or processing environment and with any type of machine that is capable of running machine-readable instructions. All or part of the processes can be implemented in digital electronic circuitry, or in computer hardware, firmware, software, or in combinations thereof.

All or part of the processes can be implemented as a computer program product, e.g., a computer program tangibly embodied in an information carrier, e.g., in one or more machine-readable storage media or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Actions associated with the processes can be performed by one or more programmable processors executing one or more computer programs to perform the functions of the processes. The actions can also be performed by, and the processes can be implemented as, special purpose logic circuitry, e.g., an FPGA (field programmable gate array) and/or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only storage area or a random access storage area or both. Elements of a computer include a processor for executing instructions and one or more storage area devices for storing instructions and data. Generally, a computer will also include, or be operatively coupled to receive data from, or transfer data to, or both, one or more mass storage devices for storing data, e.g., magnetic, magneto-optical disks, or optical disks. Information carriers suitable for embodying computer program instructions and data include all forms of non-volatile storage area, including by way of example, semiconductor storage area devices, e.g., EPROM (erasable programmable read-only memory), EEPROM (electrically erasable programmable read-only memory), and flash storage area devices; magnetic disks, e.g., internal hard disks or removable disks; magneto-optical disks; and CD-ROM (compact disc read-only media) and DVD-ROM (digital versatile disc read-only memory) disks.

All or part of the processes can be implemented in a computing system that includes a back-end component, e.g., as a data server, or that includes a middleware component, e.g., an application server, or that includes a front-end component, e.g., a client computer having a graphical user interface, or any combination of such back-end, middleware, or front-end components. The components of the system can be interconnected by any form or medium of digital data communication, e.g., a communication network. Examples of communication networks include a LAN (local area network) and a WAN (wide area network), e.g., the Internet.

Actions associated with the processes can be rearranged and/or one or more such actions can be omitted to achieve the same, or similar, results to those described herein.

Elements of different implementations may be combined to form implementations not specifically described herein.

In using the term “may,” it is understood to mean “could, but not necessarily must.”

Numerous uses of and departures from the specific apparatus and techniques disclosed herein may be made without departing from the inventive concepts. Consequently, the invention is to be construed as embracing each and every novel feature and novel combination of features disclosed herein and limited only by the spirit and scope of the appended claims.

What is claimed is:

1. A method comprising:
receiving input data via a touchpad of a remote control;
wherein, in a relative mapping mode, the input data is used to select a menu on a display;
wherein, in an absolute mapping mode, the input data is used to select an item from items on the selected menu on the display;
analyzing the input data to determine whether to enable the relative mapping mode or the absolute mapping mode; and
automatically enabling the relative mapping mode or the absolute mapping mode based on analysis of the input data.

2. The method of claim 1, wherein, in the absolute mapping mode, areas of the touchpad are mapped to geographically corresponding items on the selected menu.

3. The method of claim 1, wherein the touchpad is positioned above actuatable elements used to provide the input data.

4. The method of claim 1, wherein predefined interactions with the touchpad correspond to the input data, the predefined interactions comprising at least one of speed, acceleration, direction, or distance corresponding to the interaction.

5. The method of claim 1, wherein predefined interactions with the touchpad correspond to the input data, the predefined interactions comprising applied pressure at a side of the touchpad.

6. The method of claim 1, wherein the input data corresponds to data generated by electronically sweeping a pressure-sensitive surface of the touchpad to locate a position of an element on the touchpad and by monitoring actuatable elements positioned beneath the touchpad.

7. A computer program product tangibly embodied in one or more information carriers, the computer program product comprising instructions that are executable by one or more processing devices to:
receive input data via a touchpad of a remote control;
wherein, in a relative mapping mode, the input data is used to select a menu on a display;
wherein, in an absolute mapping mode, the input data is used to select an item from items on the selected menu on the display;
analyze the input data to determine whether to enable the relative mapping mode or the absolute mapping mode; and
automatically enable the relative mapping mode or the absolute mapping mode based on analysis of the input data.

8. The computer program product of claim 7, wherein, in the absolute mapping mode, areas of the touchpad are mapped to geographically corresponding items on the selected menu.

9. The computer program product of claim 7, wherein the touchpad is positioned above actuatable elements used to provide the input data.

10. The computer program product of claim 7, wherein predefined interactions with the touchpad correspond to the input data, the predefined interactions comprising at least one of speed, acceleration, direction, or distance corresponding to the interaction.

11. The computer program product of claim 7, wherein the input data corresponds to data generated by electronically sweeping a pressure-sensitive surface of the touchpad to locate a position of an element on the touchpad and by monitoring actuatable elements positioned beneath the touchpad.

12. A system comprising:
an apparatus configured to receive input data via a touchpad of a remote control;
wherein, in a relative mapping mode, the input data is used to select a menu on a display;
wherein, in an absolute mapping mode, the input data is used to select an item from items on the selected menu on the display;
the apparatus comprising:
memory configured to store instructions for execution; and
one or more processing devices configured to execute the instructions, the instructions for causing the one or more processing devices to:
analyze the input data to determine whether to enable the relative mapping mode or the absolute mapping mode; and
automatically enable the relative mapping mode or the absolute mapping mode based on analysis of the input data.

13. The system of claim 12, further comprising:
the remote control, wherein the remote control includes the touchpad and is configured to send the input data to the apparatus.

14. The system of claim 12, further comprising:
a display device including the display.

15. The system of claim 12, wherein the apparatus further comprises the remote control.

16. The system of claim 12, wherein, in the absolute mapping mode, areas of the touchpad are mapped to geographically corresponding items on the selected menu.

17. The system of claim 12, wherein the touchpad is positioned above actuatable elements used to provide the input data.

18. The system of claim 12, wherein predefined interactions with the touchpad correspond to the input data, the predefined interactions comprising at least one of speed, acceleration, direction, or distance corresponding to the interaction.

19. The system of claim 12, wherein the remote control is configured to electronically sweep a pressure-sensitive surface of the touchpad to locate a position of an element on the touchpad and to monitor actuatable elements positioned beneath the touchpad to generate data corresponding to the input data.

20. A method comprising:
automatically transitioning between a relative mapping mode and an absolute mapping mode based on analysis of input data received via a touchpad of a remote control;
wherein, in a relative mapping mode, the input data is used to select a menu on a display; and
wherein, in an absolute mapping mode, the input data is used to select an item from items on the selected menu on the display.

21. A method comprising:
launching an on-screen display as first video content on a display of a display device in response to first input data received via a touchpad of a remote control, wherein the on-screen display includes two or more menus and the on-screen display, when launched, overlays at least a portion of second video content shown on the display, and wherein the display device and the remote control are separate physical devices;
activating a menu of the two or more menus to reveal items in response to second input data received via the touchpad of the remote control;
selecting a revealed item of an activated menu in response to third input data received via the touchpad of the remote control; and
modifying the second video content in response to selection of the revealed item.

22. The method of claim 21, further comprising:
providing focus on a particular menu of the two or more menus by highlighting the particular menu.

23. The method of claim 21, further comprising:
shifting focus between menus of the two or more menus responsively to fourth input data.

24. The method of claim 21, wherein activating the menu of the two or more menus comprises enlarging the menu relative to another menu of the two or more menus.

25. The method of claim 21, wherein selecting the revealed item comprises highlighting the revealed item.
